(19) United States
(12) Patent Application Publication
(10) Pub. No.: US 2025/0158851 A1
(43) Pub. Date: May 15, 2025

(54) METHOD AND APPARATUS OF CHANNEL ESTIMATION IN ULTRA-WIDEBAND COMMUNICATION

(71) Applicant: Ohio State Innovation Foundation, Columbus, OH (US)

(72) Inventors: Poline Y. Xian, Hong Kong (CN); Chongchang Mao; Ye Xue, Hong Kong (CN); Haiming Zhang, Hong Kong (CN); Jian-Feng Cai, Hong Kong (CN)

(21) Appl. No.: 18/946,152

(22) Filed: Nov. 13, 2024

Related U.S. Application Data
(60) Provisional application No. 63/598,229, filed on Nov. 13, 2023.

(51) Int. Cl. H04L 25/02; H04B 17/336

(52) U.S. Cl. CPC H04L 25/0224; H04B 17/336

(57) ABSTRACT

Systems, apparatuses, methods, and computer program products are disclosed for adaptive transmission with improved channel estimation for ultra-wideband communications. An example method includes receiving a set of reference signals. The example method also includes determining, using the set of reference signals, estimated channel error information for a channel. The example method also includes modifying a Signal-to-Interference-plus-Noise Ratio (SINR) based on the estimated channel error information. The example method also includes modifying a channel capacity based on the estimated channel error information. The example method also includes determining channel state information based on the modified SINR and the modified channel capacity. The example method also includes outputting the channel state information.

### CROSS-REFERENCE TO RELATED APPLICATIONS

This patent application claims the benefit of U.S. Provisional Patent Application No. 63/598,229, filed Nov. 13, 2023, the entire contents of which are incorporated by reference herein.

### BACKGROUND

The rapid evolution of wireless communication technologies requires ultra-high-speed and reliable data transmission. Efficient and reliable computational algorithms are crucial to address the challenges associated with low latency and large-scale data transmission in communication networks, such as fifth-generation (5G) and sixth generation (6G) communication networks.

### BRIEF SUMMARY

In some embodiments, a method is provided for adaptive transmission with improved channel estimation for ultra-wideband communications. The method comprises receiving a set of reference signals. The method also comprises determining, using the set of reference signals, estimated channel error information for a channel. The method also comprises modifying a Signal-to-Interference-plus-Noise Ratio (SINR) based on the estimated channel error information. The method also comprises modifying a channel capacity based on the estimated channel error information. The method also comprises determining channel state information based on the modified SINR and the modified channel capacity. The method also comprises outputting the channel state information.

In some embodiments, determining the estimated channel error information comprises determining a least square estimation of the channel based at least on a vectorization of a reference signal, determining a channel covariance matrix based on the least square estimation, performing subspace noise filtering on the channel covariance matrix, performing an LDL operation on an inverse of the channel covariance matrix, and performing an element-by-element determination of a product of the least square estimation, the channel covariance matrix, and the inverse of the channel covariance matrix.

In some embodiments, performing the subspace noise filtering is based on a corresponding eigenvalue of the channel covariance matrix that is less than a predefined threshold.

In some embodiments, the element-by-element determination comprises vectorizing the channel covariance matrix and a pre-estimated channel.

In some embodiments, modifying the SINR comprises determining a channel estimation error, determining a modification parameter by determining a conjugate of a product of the channel estimation error and a precoding matrix, and multiplying the conjugate by the inverse of the channel covariance matrix, an estimated channel matrix, and the precoding matrix, and determining a SINR modification value by multiplying a precomputed SINR value with a value of a subtraction of the product of the modification parameter from an identity matrix, the precomputed SINR value, and twice an amplitude of the channel estimation error.

In some embodiments, the precomputed SINR value is based on a multiplication of a conjugate of the estimated channel matrix, the inverse of the channel covariance matrix, and the estimated channel matrix.

In some embodiments, modifying the channel capacity comprises, for each layer, determining a difference between an identity matrix and a product of the modification parameter, the precomputed SINR value, and twice the amplitude of the channel estimation error, determining a value corresponding to a logarithm of the difference, and summing values of each layer.

In some embodiments, determining the channel estimation error comprises determining a scaling parameter based on an absolute value of a computed error, and determining an angle parameter based on dividing the channel estimation error by the absolute value of the computed error.

In some embodiments, outputting the channel state information comprises comparing a scaling parameter to a predefined threshold.

In some embodiments, the method further comprises, in response to the scaling parameter satisfying the predefined threshold, re-computing the channel state information with the modified SINR and the modified channel capacity, or in response to the scaling parameter not satisfying the predefined threshold, not re-computing the channel state information.

In some embodiments, an apparatus is provided for adaptive transmission with improved channel estimation for ultra-wideband communications. The apparatus comprises a processor. The apparatus also comprises memory storing instructions that, when executed by the processor, cause the apparatus to receive a set of reference signals. The instructions, when executed by the processor, also cause the apparatus to determine, using the set of reference signals, estimated channel error information for a channel. The instructions, when executed by the processor, also cause the apparatus to modify a Signal-to-Interference-plus-Noise Ratio (SINR) based on the estimated channel error information. The instructions, when executed by the processor, also cause the apparatus to modify a channel capacity based on the estimated channel error information. The instructions, when executed by the processor, also cause the apparatus to determine channel state information based on the modified SINR and the modified channel capacity. The instructions, when executed by the processor, also cause the apparatus to output the channel state information.

In some embodiments, the instructions, when executed by the processor, cause the apparatus to determine the estimated channel error information by determining a least square estimation of the channel based at least on a vectorization of a reference signal, determining a channel covariance matrix based on the least square estimation, performing subspace noise filtering on the channel covariance matrix, performing an LDL operation on an inverse of the channel covariance matrix, and performing an element-by-element determination of a product of the least square estimation, the channel covariance matrix, and the inverse of the channel covariance matrix.

In some embodiments, performing the subspace noise filtering is based on a corresponding eigenvalue of the channel covariance matrix that is less than a predefined threshold.

In some embodiments, the element-by-element determination comprises vectorizing the channel covariance matrix and a pre-estimated channel.

The instructions, when executed by the processor, also cause the apparatus to the instructions, when executed by the processor, cause the apparatus to modify the SINR by determining a channel estimation error, determining a modification parameter by determining a conjugate of a product of the channel estimation error and a precoding matrix, and multiplying the conjugate by the inverse of the channel covariance matrix, an estimated channel matrix, and the precoding matrix, and determining a SINR modification value by multiplying a precomputed SINR value with a value of a subtraction of the product of the modification parameter from an identity matrix, the precomputed SINR value, and twice an amplitude of the channel estimation error.

In some embodiments, the precomputed SINR value is based on a multiplication of a conjugate of the estimated channel matrix, the inverse of the channel covariance matrix, and the estimated channel matrix.

In some embodiments, the instructions, when executed by the processor, cause the apparatus to modify the channel capacity by, for each layer, determining a difference between an identity matrix and a product of the modification parameter, the precomputed SINR value, and twice the amplitude of the channel estimation error, determining a value corresponding to a logarithm of the difference, and summing values of each layer.

In some embodiments, the instructions, when executed by the processor, cause the apparatus to determine the channel estimation error by determining a scaling parameter based on an absolute value of a computed error, and determining an angle parameter based on dividing the channel estimation error by the absolute value of the computed error.

In some embodiments, outputting the channel state information comprises comparing a scaling parameter to a predefined threshold.

In some embodiments, the instructions, when executed by the processor, further cause the apparatus to, in response to the scaling parameter satisfying the predefined threshold, re-computing the channel state information with the modified SINR and the modified channel capacity, or in response to the scaling parameter not satisfying the predefined threshold, not re-computing the channel state information.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates an example representation of a wireless communication process with ultra-wideband signals such as optical signals and/or mmWave signals, in accordance with some example embodiments described herein.

FIG. 2 illustrates an example representation of a propagation environment in which propagation channels are affected by noise and fading effects, in accordance with some example embodiments described herein.

FIG. 3 illustrates an example representation of atmospheric effects on satellite-ground free space optics (FSO) communication for uplink and downlink channels, in accordance with some example embodiments described herein.

FIG. 4 illustrates an example block diagram of an example Orthogonal Frequency Division Multiplexing (OFDM) communication system, in accordance with some example embodiments described herein.

FIG. 5 illustrates an example representation of a mmWave wireless communication process, in accordance with some example embodiments described herein.

FIG. 6 illustrates an example representation of an optical wireless communication process, in accordance with some example embodiments described herein.

FIG. 7 illustrates an example flowchart for an example channel state information determination process, in accordance with some example embodiments described herein.

FIG. 8 illustrates an example representation of a channel estimation process, in accordance with some example embodiments described herein.

FIG. 9 illustrates a diagram of determining a covariance matrix with a vectorized input, in accordance with some example embodiments described herein.

FIG. 10 illustrates an example flowchart for determining a modification parameter value D for a Signal-to-Interference-plus-Noise Ratio (SINR) based on channel estimation error, in accordance with some example embodiments described herein.

FIG. 11 illustrates an example flowchart for determining a modified SINR, in accordance with some example embodiments described herein.

FIG. 12 illustrates an example flowchart for computing the modified channel capacity under channel estimation error, in accordance with some example embodiments described herein.

FIG. 13 illustrates an example flowchart for determining an output CSI value based on a level of channel estimation error, in accordance with some example embodiments described herein.

FIG. 14 is a graph of simulation results showing throughput improvement from methods and operations describe herein.

FIG. 15 illustrates graphs of simulation results simulation results showing throughput improvement from methods and operations describe herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

As mentioned above, communication networks such as 5G and 6G communication networks require high-speed reliable data transmission to function effectively. These networks may use millimeter wave (mmWave) technology which offers very high bandwidth and enables fast data rates with support for more connected devices, mmWave technology includes high-frequency bands (e.g., ranging between 24 gigahertz (GHz) to 100 GHz in the electromagnetic spectrum) which are much higher than frequencies used in previous cellular generations.

In some examples, these communication networks may also utilize free space optics (FSO) which involves using light to transmit data through the air rather than using radio frequencies. FSO is advantageous in that it can deliver very high data rates over long distances with low latency while also being unaffected by electromagnetic interference.

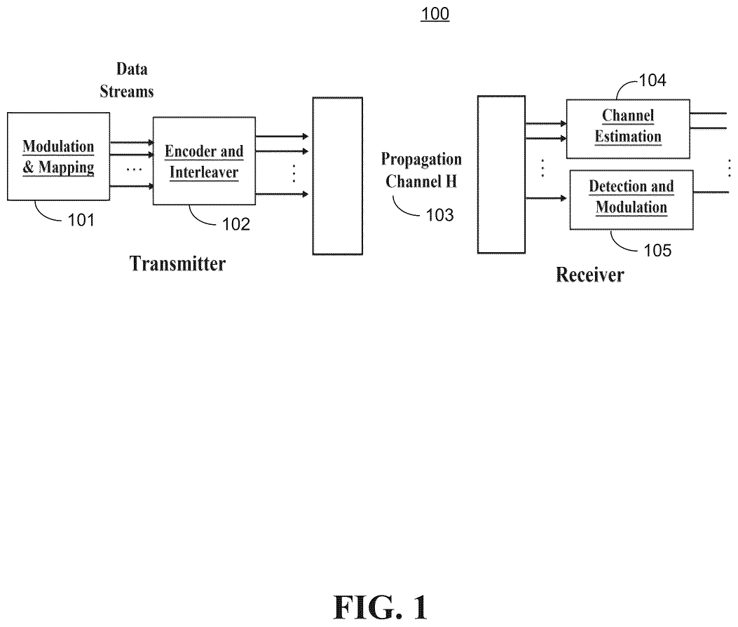

A typical communication process 100 for communication networks such as a 5G communication network is shown for example in FIG. 1. As shown, digital data to be transmitted may be organized into a plurality of data streams. On the transmitter side, digital data may undergo modulation and mapping processes 101, which may involve translating digital data into an analog waveform suitable for transmission over the air. This may involve various modulation schemes to adjust factors such as amplitude and frequency of a carrier signal according to the data. Additionally, data bits may be mapped into symbols or groups of bits for transmission, where each symbol represents a unique combination of bits. Encoder and interleaver processes 102 may be performed in order to reduce errors. For example, encoding may introduce redundancy to help correct errors caused by noise or other interference during transmission of the data, while interleaving may shuffle data bits before transmission to reduce the effect of a burst error.

As shown in FIG. 1, the data may then be sent through a propagation channel 103 (e.g., air, fiber optics, or other transmission mediums) which may introduce fading, noise, or other interference due to long distance, obstacles, and/or other environmental factors. The receiver may perform channel estimation 104 to identify the effects of the transmission medium on the signal. Pilot signals may be sent periodically and used to make the channel estimation determination. Channel estimation error may comprise the difference between the perfect channel and the imperfect channel. The imperfect channel estimation affects the modulation method, resource allocation efficiency, and the data transmission method of a communication system. In other words, a communication system may use channel estimation to characterize the effects of the transmission channel on a signal. The channel may be affected by fading, noise, interference, path loss, and the like, which can distort the transmitted signal. Channel estimation enables the receiver to understand and compensate for this distortion and ensure that the received signal is as close as possible to the original transmitted signal.

Additionally, detection and modulation processes 105 may be performed at the receiver. For example, the receiver may attempt to detect the transmitted symbols and correct for any errors caused during transmission over the propagation channel. The receiver may also convert detected analog signals back into digital data (reversing the modulation performed at the transmitter) in order to obtain output data which should ideally closely match the original transmitted data.

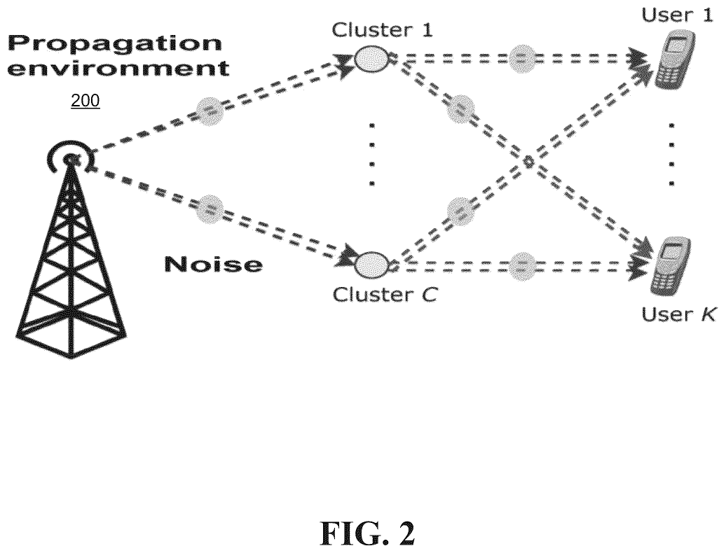

Obtaining robust channel state information under a perturbed environment is a challenge. For example, FIG. 2 shows an example visual representation of propagation environment 200 in which propagation channels are affected by noise and fading. Propagation channels may be affected by noise and fading as signals travel between the transmitter, clusters (i.e., objects causing scattering of the signal), and receivers. Noise may introduce random variations which reduces clarity and increases error in the signal. Fading refers to the variation in signal strength caused by obstacles, reflections, and other interferences which can affect the signal.

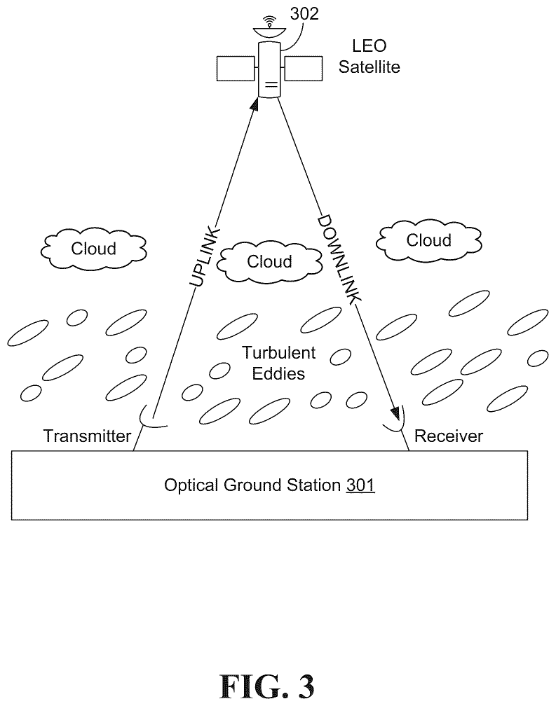

FIG. 3 shows an example visual representation of atmospheric effects on satellite-ground free space optics (FSO) communication for uplink and downlink channels. For example, in satellite communications involving an optical ground station 301 sending and receiving data via uplink and downlink with a low earth orbit (LEO) satellite 302, channel estimation errors may arise from environmental factors such as turbulent eddies. Turbulent eddies (which may be caused by variable temperature and/or pressure) may create turbulence which disrupts signal path and causes fluctuations in intensity and phase of the signal. This unpredictable and rapid change in channel properties introduces additional challenges for accurate channel estimation.

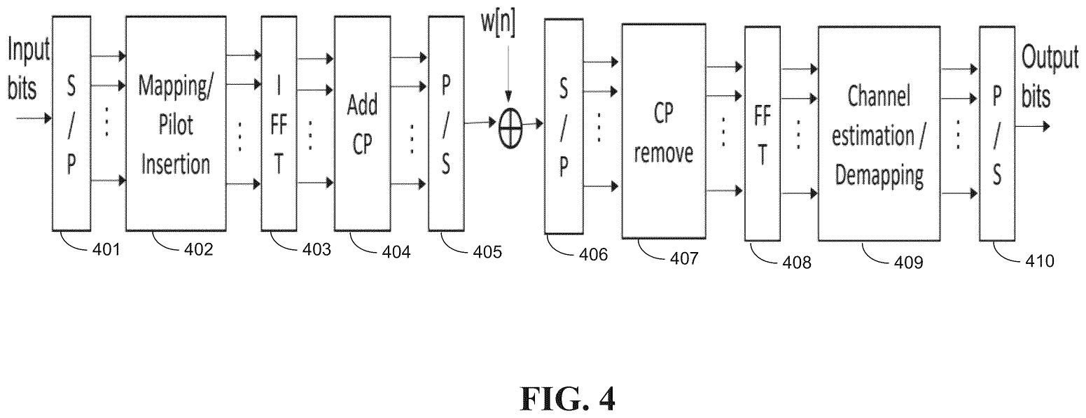

Orthogonal Frequency Division Multiplexing (OFDM) is a multi-carrier transmission technology in wireless communication. With the use of orthogonal carrier technology without interference and no guard band between single carriers, an OFDM system requires much less bandwidth compared with other systems while achieving higher bandwidth utilization. OFDM may be used in an optical wireless communication system. An example block diagram of an example OFDM communication system is shown in FIG. 4.

As shown in FIG. 4, at a transmitter, a data sequence may be converted 401 into parallel segments by the number of carriers. Mapping and pilot insertion 402 may involve mapping the data sequence into a symbol stream, and inserting pilot signals (i.e., known reference signals) at certain positions within each OFDM symbol. In some examples, pilot signals may be inserted at the transmitter (and receiver) in order to assist with channel estimation. Different coding may be used for each carrier symbol sequence to convert them into complex phase representations. The sequence is then assigned 403 to the appropriate Inverse Fast Fourier Transform (IFFT) bin. Fast Fourier transform (FFT) may be used for high-speed realization of modulation and demodulation of the multi-carrier baseband. The cyclic prefix (CP) is added 404 and is used between symbols to satisfy the orthogonality of each carrier in dispersive channels. Parallel to serial conversion 405 may be used to rebuild the original serial bitstream in a final step performed at the transmitter. At a receiver, the OFDM signal is down-converted 406. The CP may be removed 407 and the data stream may be divided into in-phase (I) and quadrature (Q) components. This results in a series of complex samples. FFT may be used 408 to reduce the complex waveforms in the symbol period to N complex values, with each representing a modulation symbol on one subcarrier. Channel estimation and demapping may be performed 409. To recover the bits, demapping may be used for demodulation. A final step at the receiver may involve parallel to serial conversion 410 to rebuild the serial bitstream.

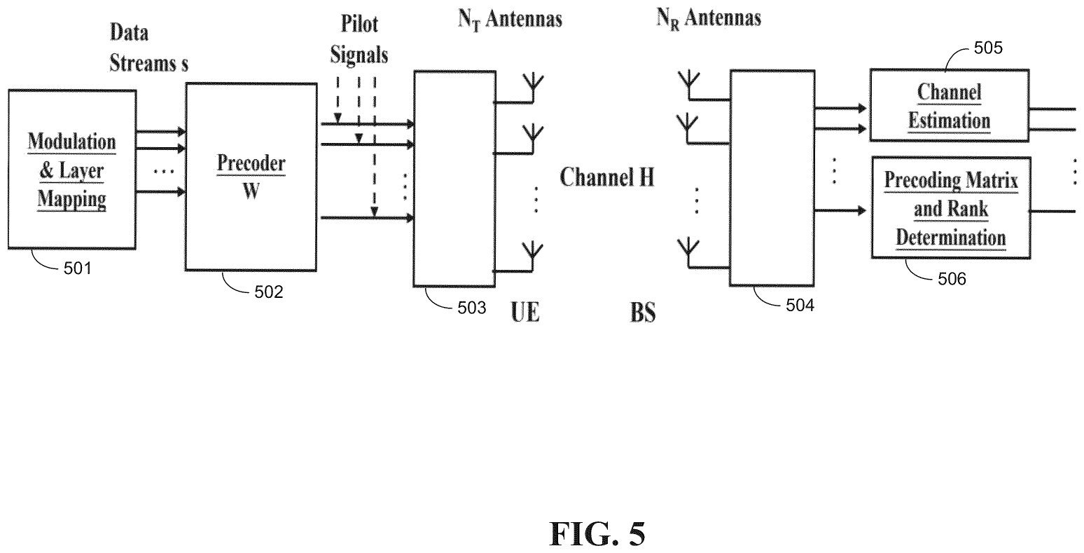

5G New Radio (NR) employs a suite of advanced technologies (including OFDM) to enhance the efficiency and capabilities of the network. An example communication process within the NR framework with OFDM technology is illustrated in FIG. 5. In the NR framework, beamforming may be used for adequate reception and obtains propagation channel state information (CSI) coefficients through the use of pilot signals. CSI coefficients may include rank, precoding matrix, and channel matrix. In the uplink case, the sounding reference signal (SRS) may be transmitted from user equipment (UE) to base stations (BS) for location and communication sensing. In the downlink case, the channel state information reference signal (CSI-RS) is used to have the CSI coefficients.

As shown in FIG. 5, for example, data streams may be generated at UE and undergo modulation and layer mapping processes 501. Each data stream may be modulated to map bits onto complex symbols, and modulated symbols are mapped onto separate layers which allows multiple data streams to be transmitted simultaneously via different antennas. Precoding may involve adapting each layer's signal to current channel conditions. A precoder 502 may comprise a matrix that is applied to the layered data, which optimizes how data streams align with channel characteristics between the UE and BS. Pilot signals may be interspersed with data to enable the base station to estimate the channel's properties. After precoding, layered and mapped signals are sent through an antenna array 503 at the UE to transmit the data streams in parallel. During transmission, the data may encounter factors including noise, fading, and other interference which distorts the signals.

At the BS, the data may be received by an antenna array 504. The BS may perform channel estimation 505 to assess how the channel affected the transmitted signals. Precoding matrix and rank determination 506 may then be performed. Precoding matrix determination may involve using the estimated channel characteristics to determine an optimal precoding matrix. Rank determination may involve calculating the rank (e.g., number of independent data streams that can be reliably sent across the channel) of the transmission.

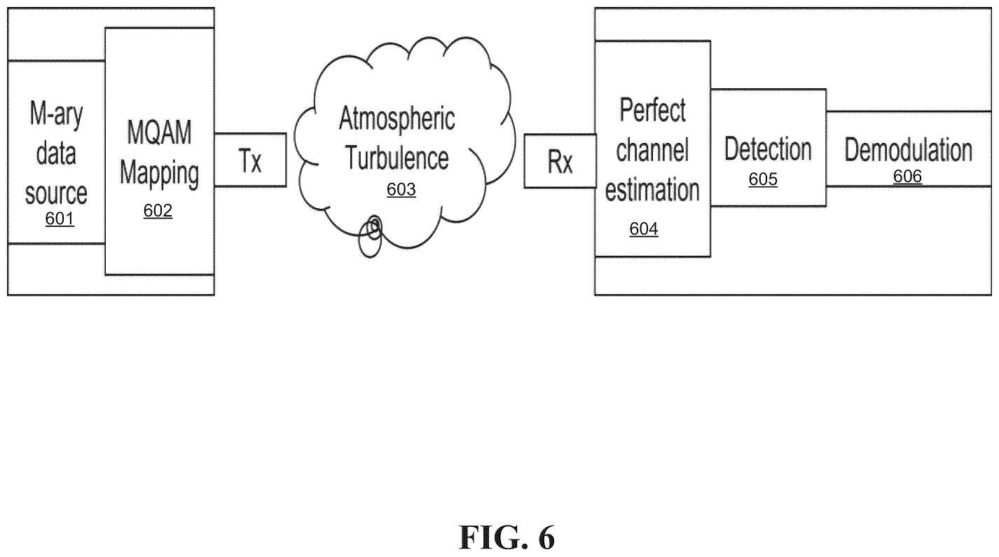

In optical communication systems which use an OFDM framework, pilot signals may be used to obtain channel information. An example optical wireless communication process is shown for example in FIG. 6, where data may be transmitted via light waves through free space. As shown, for example, at the transmitter end, an M-ary data source 601 may generate symbols (with M being the number of unique symbols) that represent multiple bits of information. MQAM (Quadrature Amplitude Modulation) mapping 602 may involve modulating the M-ary data wherein each symbol is mapped to a unique point in a grid of phase and amplitude values. The modulated signal may then be converted into an optical signal suitable for free space transmission. The optical signal may be transmitted through the atmosphere and experience atmospheric turbulence 603 caused by, for example, wind, pressure, temperature, and/or the like. At the receiver end, perfect channel estimation 604 may be achieved by comparing received pilot signals with known transmitted values. Detection 605 may comprise equalizing the received signal to account for distortions caused by atmospheric turbulence 603, and demodulation 606 may comprise demodulating the signal by mapping symbol points back to corresponding bit values.

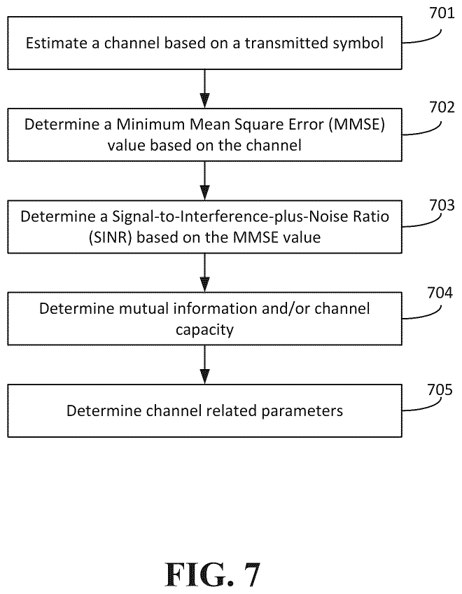

A flowchart of an example channel state information (CSI) determination process is shown in FIG. 7. In various examples, a system may determine and use CSI to determine a transmission method and resource allocation. In other words, a system may use CSI to adapt how data is transmitted and allocate resources efficiently. As shown in FIG. 7, the example CSI determination process comprises estimating channel based on a transmitted symbol at operation 701. The example CSI determination process also comprises determining a Minimum Mean Square Error (MMSE) value based on the channel at operation 702. The example CSI determination process also comprises determining a Signal-to-Interference-plus-Noise Ratio (SINR) based on the MMSE value at operation 703. In some embodiments, the SINR value may be computed based on the MMSE receiver, which may be conditional on the channel matrix H. The example CSI determination process also comprises determining mutual information and/or channel capacity at operation 704. The example CSI determination process also comprises determining channel related parameters at operation 705. In some embodiments, the CSI, which may comprise a modulation method, encoding method, and transmission rank, may be determined based on the value of channel capacity. In some embodiments, the channel capacity may be based on the value of the SINR.

When channel estimation is not accurate, data throughput drops significantly due to increased packet re-transmission. Having a robust channel estimation is crucial for transmission stability and efficiency. Two example approaches to channel estimation are correlation-based methods and the least-squares based methods. The correlation-based methods are biased when there is noise interference, while the least-squares based method is unbiased. These channel estimation methods have a high computational cost, which is induced by the inversion of large matrices.

In prior channel estimation methods, hybrid correlation and least squares channel estimation methods may typically be combined used to improve channel estimation accuracy. Such methods result in various drawbacks and inefficiencies, including a need for two steps of estimation and parameter tuning which increases computational complexity and processing time. This delay is especially evident in high-speed and real-time communication systems where the need for fast channel estimation is critical. In addition, the computation complexity of matrix inversion in the least square estimation is high, and the estimation is not accurate when noise is present.

Accordingly, in various embodiments of the present inventive concept, features of fast computation, noise filtering, and error estimation can be realized through matrix factorization and error approximation computational techniques. Channel estimation with such features has special applications in high-speed data transfer, low latency, and environmental robustness.

In some embodiments, a method of reducing computational costs in the least square channel estimation is provided. In some embodiments, the input signal may be vectorized such that the least square estimation process may be computed element-wise. In some embodiments, in the MMSE filtering, the sub-space noise filtering and thresholding are imposed on the computed covariance matrix, and the LDL operation is also imposed. The covariance matrix inversion becomes the ensemble of the element-by-element inverse process. In this case, the computational cost is reduced greatly, and the estimation accuracy under noise is improved.

In some embodiments, SINR and channel capacity modification may be performed based on channel estimation error. In some embodiments, the modification value of SINR may be computed based on the error level. With the precomputed modification and look-up table, the SINR and channel capacity are modified under different noise levels. This reduces the computational cost of the subsequent channel-related coefficient determination.

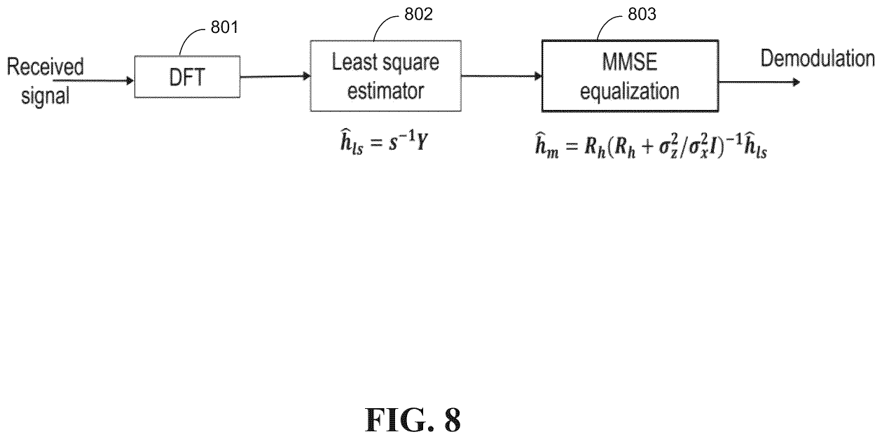

As described above, a framework of channel estimation in ultra-wideband communication in shown in FIG. 7, which includes channel improvement and error identification and SINR modification based on estimation error. A general channel estimation process is shown for example in FIG. 8. As shown, a received signal may undergo a discrete Fourier Transform (DFT) 801, a least square estimator determination 802, and an MMSE equalization 803 prior to demodulation. The least square estimation is generally used for estimation, follow by MMSE equalization. In FIG. 8, Y is the received information, s is the transmitted symbol, Rh is the channel estimation correlation matrix, σ_{z}² is the noise variance, and σₓ² is the received data variance.

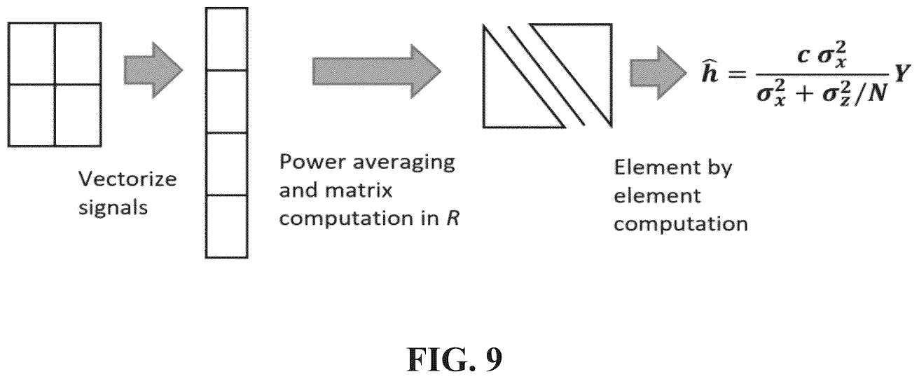

For the channel estimation improvement, FIG. 9 shows a diagram of determining a covariance matrix with a vectorized input. As shown in FIG. 9, to accelerate the computation speed and enhance estimation accuracy, the input signal is vectorized, and the power averaging and LDL matrix factorization methods are imposed, the covariance matrix inversion in the MMSE equalization process becomes the ensemble of the element-by-element computation process, thereby greatly reducing computational complexity.

To enhance channel estimation accuracy, the subspace noise cancellation method is used. Considering the interference of channels, express the channel covariance is expressed as:

$${R}_{h} = [ {U}_{hs} {U}_{hn} ] diag ( {τ}_{1} , … {τ}_{L} ) [ {U}_{hs} {U}_{hn} ]$$

A threshold T may be set for the eigenvalue of the channel covariance τᵢ to separate signal and noise components. The noise can be filtered out through this process and the channel estimation accuracy under the noisy channel is improved. The channel estimation error is the difference between the modified channel information and the least square channel estimation. That is:

$$Δ h = {h}_{m} - {h}_{ls} .$$

The difference can also be expressed as:

$$Δ h = ε A = \vert Δh \vert \cdot \frac{Δ h}{\vert Δ h \vert}$$

In the above expression, A is the error distribution matrix, and ε is the error scalar level.

The received signal Y under perturbation and channel uncertainty may be expressed as:

$$Y = ( H + Δ ) W s + n ,$$

where H is the true channel matrix, Δ is the error term, W is the precoding matrix, and s is the transmitted pilot symbol, and n is the noise term.

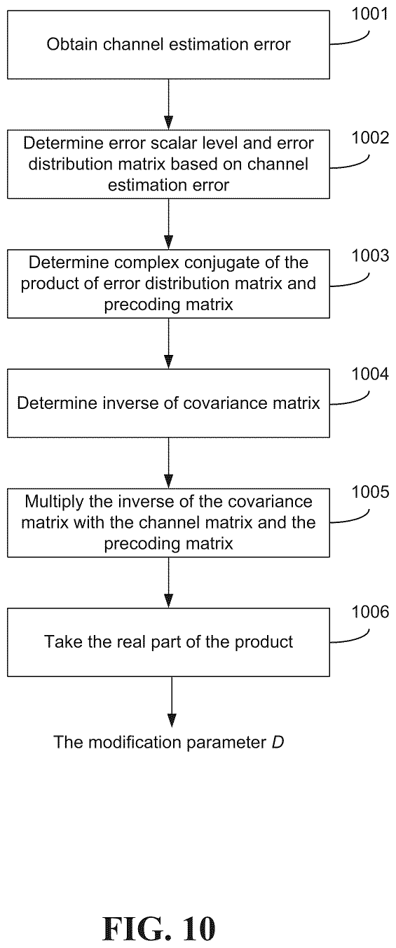

FIG. 10 shows a flowchart for determining the modification parameter value D for the SINR based on the channel estimation error. As shown in operation 1001, the channel estimation error Δ is estimated as described above. At operation 1002, the scalar ε and the related matrix A may be determined based on the channel estimation error Δ. At operation 1003, the error matrix A and the precoding matrix W are multiplied and the complex conjugate of the product is taken, expressed as (AW)^{H}. At operation 1004, the inverse of the covariance matrix R is determined, expressed as R⁻¹. At operation 1005, R⁻¹ may be right multiplied with the channel matrix H and the precoding matrix W. This product may then be left multiplied with (AW)^{H}, expressed as (AW)^{H}R⁻¹(HW). At operation 1006, the real part of the product may be taken, and thus the SINR modification parameter D is expressed as:

Re[(AW)^{H}R⁻¹(HW)]

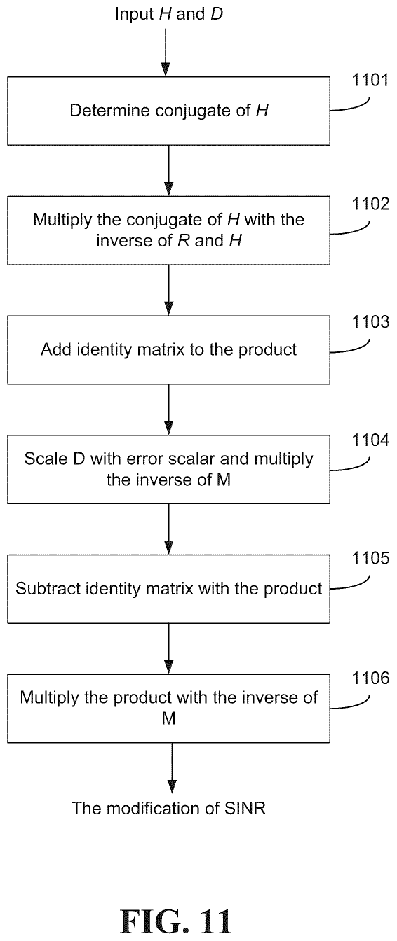

Based on the SINR modification parameter D, the adjusted SINR can be determined using the process shown in FIG. 11.

As shown in FIG. 11, the channel matrix H and SINR modification parameter D may be provided as inputs. At operation 1101, the conjugate of H is taken, expressed as H^{H}. At operation 1102, H^{H} is right multiplied with the inverse of R and H, expressed as H^{H}R⁻¹ H. At operation 1103, the identity matrix I_{L} is added to the product, which produces the MMSE receiver matrix, expressed as: M=H^{H} R⁻¹H+I_{L}. At operation 1104, the inverse of the MMSE matrix is taken and right multiplied with the modification matrix D and error scalar 28, expressed as 2εD(H^{H} R⁻¹H+I_{L})⁻¹. At operation 1105, this product is subtracted from the identity matrix expressed as I−2εD(H^{H} R⁻¹H+I_{L})⁻¹. At operation 1106, this product is right multiplied with the inverse of the MMSE matrix. The modification value of the SINR is thus expressed as M⁻¹(I−2εD(H^{H} R⁻¹H+I_{L})⁻¹).

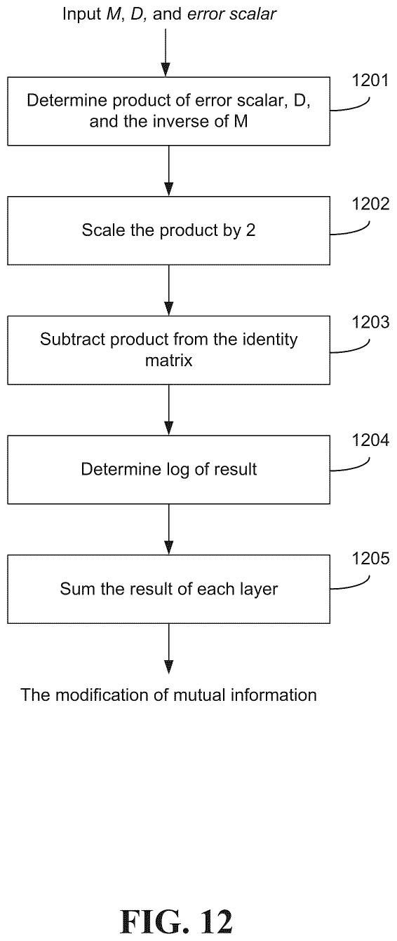

FIG. 12 shows example operations for determining modified channel capacity under the channel estimation error.

As shown in FIG. 12, the MMSE receiver matrix M, the modification parameter D, and error scalar ε may be provided as inputs. At operation 1201, ε, D and the inverse of M are multiplied to determine a product, expressed as εDM⁻¹. At operation 1202, the product is scaled by 2, expressed as 2εDM⁻¹. At operation 1203, the product is subtracted from the identity matrix, expressed as I−2εDM⁻¹. At operation 1204, the log of the result of operation 1203 is taken, expressed as log₂(I−2εDM⁻¹). At operation 1205, results of each layer are summed. The modification on mutual information is then determined to sum the log operation value, expressed as Σₗ log₂(I−2εDM⁻¹). Based on the adjusted SINR and the modified channel capacity, the channel-related coefficients (such as the modulation method, transmission rank, and encoding method) can be determined under the actual channel environment, and resources can be better allocated based on the transmitted environment.

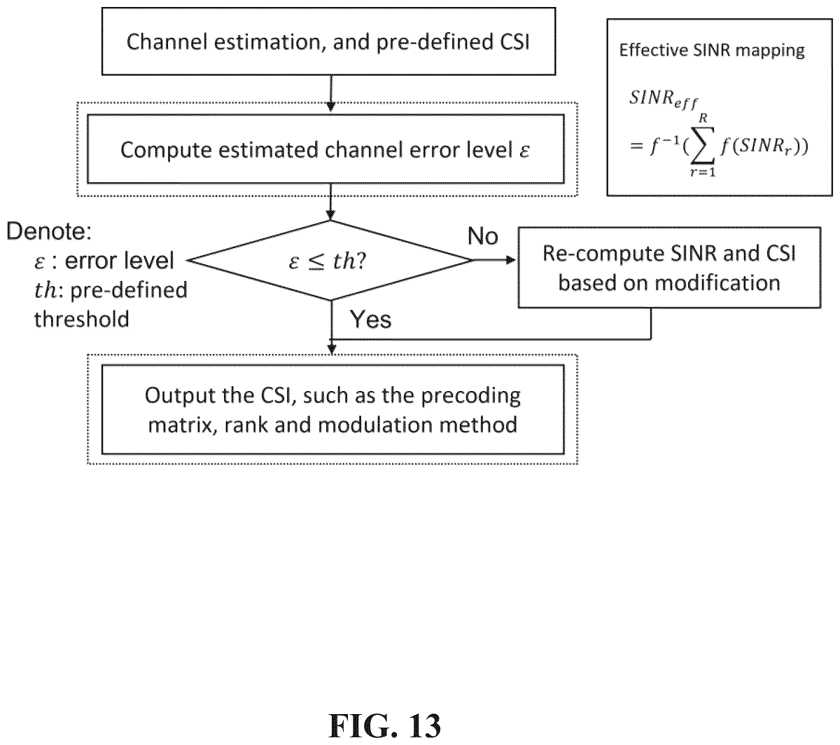

FIG. 13 shows an example flowchart of the output CSI value (e.g., precoding matrix, rank, and modulation method) based on the level of the channel estimation error. As shown in FIG. 13, in some embodiments, a predefined threshold th may be set, and when the channel estimation error ε is less than or equal to the threshold th, the SINR value and the corresponding CSI value are computed again. When the threshold value th is greater than the channel estimation error, the pre-computed rank, precoding scheme, and modulation will not be modified.

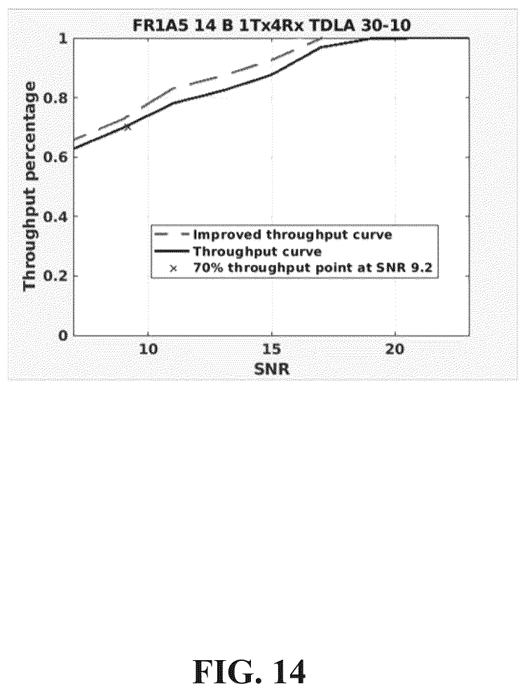

The proposed method has been tested in the throughput comparison with the conventional method. FIG. 14 shows a throughput improvement simulation result based on the method in the Tapped Delay Line-A (TDL-A) fading channel case. The fading distribution is Rayleigh distribution. The delay spread for the channel is 30 ns, and the delay resolution is 5 ns. The solid curve shows the throughput computed by the conventional method, and the dotted curve shows the throughput computed by the method described herein. In this case, the setting of one transmitter and four receivers is tested. The method has higher throughput compared with the conventional method.

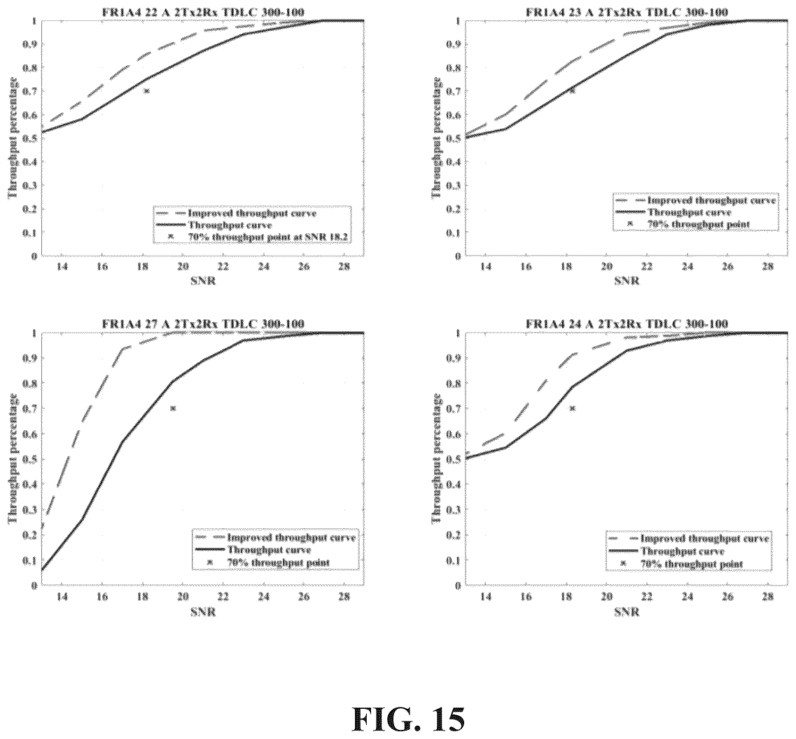

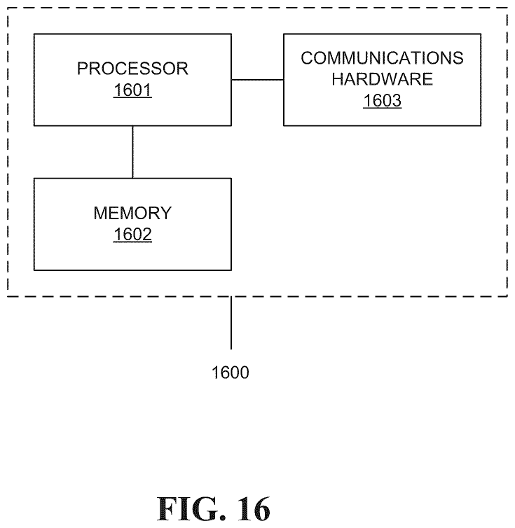

FIG. 15 shows the throughput improvement simulation results in the Tapped Delay Line-C(TDLC) fading channel cases. The channel distribution is also Rayleigh distribution. The delay spread is 300 nanoseconds (ns), and the delay resolution is 5 ns. The experimental setting is two transmitters and two receivers. For all the settings, the solid curve shows the throughput computed by the conventional method, and the dotted curve shows the throughput computed by the proposed method. As shown, the described method has higher throughput when compared with the conventional method.

The operations described herein may be performed by one or more computing devices (e.g., a receiver), shown as apparatus 1600 in FIG. 16. The apparatus 1600 may be configured to execute various operations described above in connection with FIGS. 1-13. As illustrated in FIG. 16, the apparatus 200 may include processor 1601, memory 1602, and communications hardware 1603, each of which will be described in greater detail below.

The processor 1601 (and/or co-processor or any other processor assisting or otherwise associated with the processor) may be in communication with the memory 1602 via a bus for passing information amongst components of the apparatus. The processor 1601 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 1600, remote or “cloud” processors, or any combination thereof.

The processor 1601 may be configured to execute software instructions stored in the memory 1602 or otherwise accessible to the processor. In some cases, the processor may be configured to execute hard-coded functionality. As such, whether configured by hardware or software methods, or by a combination of hardware with software, the processor 1601 represent an entity (e.g., physically embodied in circuitry) capable of performing operations according to various embodiments of the present invention while configured accordingly. Alternatively, as another example, when the processor 1601 is embodied as an executor of software instructions, the software instructions may specifically configure the processor 1601 to perform the algorithms and/or operations described herein when the software instructions are executed.

Memory 1602 is non-transitory and may include, for example, one or more volatile and/or non-volatile memories. In other words, for example, the memory 1602 may be an electronic storage device (e.g., a computer readable storage medium). The memory 1602 may be configured to store information, data, content, applications, software instructions, or the like, for enabling the apparatus to carry out various functions in accordance with example embodiments contemplated herein.

The communications hardware 1603 may be any means such as a device or circuitry embodied in either hardware or a combination of hardware and software that is configured to receive and/or transmit data from/to a network and/or any other device, circuitry, or module in communication with the apparatus 1600. In this regard, the communications hardware 1603 may include, for example, a network interface for enabling communications with a wired or wireless communication network. For example, the communications hardware 1603 may include one or more network interface cards, antennas, buses, switches, routers, modems, transceivers, amplifiers, filters, and supporting hardware and/or software, or any other device suitable for enabling communications via a network. Furthermore, the communications hardware 1603 may include the processing circuitry for causing transmission of such signals to a network or for handling receipt of signals received from a network.

In some embodiments, the communications hardware 1603 may further be configured to provide output to a user and, in some embodiments, to receive an indication of user input. In this regard, the communications hardware 1603 may comprise a user interface, such as a display, and may further comprise the components that govern use of the user interface, such as a web browser, mobile application, dedicated client device, or the like. In some embodiments, the communications hardware 1603 may include a keyboard, a mouse, a touch screen, touch areas, soft keys, a microphone, a speaker, and/or other input/output mechanisms. The communications hardware 1603 may utilize the processor 1601 to control one or more functions of one or more of these user interface elements through software instructions (e.g., application software and/or system software, such as firmware) stored on a memory (e.g., memory 1602) accessible to the processor 1601.

As will be appreciated based on this disclosure, example embodiments contemplated herein may be implemented by an apparatus 1600. Furthermore, some example embodiments may take the form of a computer program product comprising software instructions stored on at least one non-transitory computer-readable storage medium (e.g., memory 1602). Any suitable non-transitory computer-readable storage medium may be utilized in such embodiments, some examples of which are non-transitory hard disks, flash memory, optical storage devices, and magnetic storage devices. It should be appreciated, with respect to certain devices embodied by apparatus 1600 as described in FIG. 16, that loading the software instructions onto a computing device or apparatus produces a special-purpose machine comprising the means for implementing various functions described herein.

FIGS. 7, 10, 11, 12, and 13 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for adaptive transmission with improved channel estimation for ultra-wideband communications, the method comprising:
receiving a set of reference signals;
determining, using the set of reference signals, estimated channel error information for a channel;
modifying a Signal-to-Interference-plus-Noise Ratio (SINR) based on the estimated channel error information;
modifying a channel capacity based on the estimated channel error information;
determining channel state information based on the modified SINR and the modified channel capacity; and
outputting the channel state information.

2. The method of claim 1, wherein determining the estimated channel error information comprises:
determining a least square estimation of the channel based at least on a vectorization of a reference signal;
determining a channel covariance matrix based on the least square estimation;
performing subspace noise filtering on the channel covariance matrix;
performing an LDL operation on an inverse of the channel covariance matrix; and
performing an element-by-element determination of a product of the least square estimation, the channel covariance matrix, and the inverse of the channel covariance matrix.

3. The method of claim 2, wherein performing the subspace noise filtering is based on a corresponding eigenvalue of the channel covariance matrix that is less than a predefined threshold.

4. The method of claim 2, wherein the element-by-element determination comprises vectorizing the channel covariance matrix and a pre-estimated channel.

5. The method of claim 2, wherein modifying the SINR comprises:
determining a channel estimation error;
determining a modification parameter by:
determining a conjugate of a product of the channel estimation error and a precoding matrix, and
multiplying the conjugate by the inverse of the channel covariance matrix, an estimated channel matrix, and the precoding matrix; and
determining a SINR modification value by multiplying a precomputed SINR value with a value of a subtraction of the product of the modification parameter from an identity matrix, the precomputed SINR value, and twice an amplitude of the channel estimation error.

6. The method of claim 5, wherein the precomputed SINR value is based on a multiplication of a conjugate of the estimated channel matrix, the inverse of the channel covariance matrix, and the estimated channel matrix.

7. The method of claim 5, wherein modifying the channel capacity comprises, for each layer:
determining a difference between an identity matrix and a product of the modification parameter, the precomputed SINR value, and twice the amplitude of the channel estimation error;
determining a value corresponding to a logarithm of the difference; and
summing values of each layer.

8. The method of claim 5, wherein determining the channel estimation error comprises:
determining a scaling parameter based on an absolute value of a computed error, and
determining an angle parameter based on dividing the channel estimation error by the absolute value of the computed error.

9. The method of claim 1, wherein outputting the channel state information comprises comparing a scaling parameter to a predefined threshold.

10. The method of claim 9, further comprising:
in response to the scaling parameter satisfying the predefined threshold, re-computing the channel state information with the modified SINR and the modified channel capacity; or
in response to the scaling parameter not satisfying the predefined threshold, not re-computing the channel state information.

11. An apparatus for adaptive transmission with improved channel estimation for ultra-wideband communications, the apparatus comprising:
a processor; and
memory storing instructions that, when executed by the processor, cause the apparatus to:
receive a set of reference signals;
determine, using the set of reference signals, estimated channel error information for a channel;
modify a Signal-to-Interference-plus-Noise Ratio (SINR) based on the estimated channel error information;
modify a channel capacity based on the estimated channel error information;
determine channel state information based on the modified SINR and the modified channel capacity; and
output the channel state information.

12. The apparatus of claim 11, wherein the instructions, when executed by the processor, cause the apparatus to determine the estimated channel error information by:
determining a least square estimation of the channel based at least on a vectorization of a reference signal;
determining a channel covariance matrix based on the least square estimation;
performing subspace noise filtering on the channel covariance matrix;
performing an LDL operation on an inverse of the channel covariance matrix; and
performing an element-by-element determination of a product of the least square estimation, the channel covariance matrix, and the inverse of the channel covariance matrix.

13. The apparatus of claim 12, wherein performing the subspace noise filtering is based on a corresponding eigenvalue of the channel covariance matrix that is less than a predefined threshold.

14. The apparatus of claim 12, wherein the element-by-element determination comprises vectorizing the channel covariance matrix and a pre-estimated channel.

15. The apparatus of claim 12, wherein the instructions, when executed by the processor, cause the apparatus to modify the SINR by:
determining a channel estimation error;
determining a modification parameter by:
determining a conjugate of a product of the channel estimation error and a precoding matrix, and
multiplying the conjugate by the inverse of the channel covariance matrix, an estimated channel matrix, and the precoding matrix; and
determining a SINR modification value by multiplying a precomputed SINR value with a value of a subtraction of the product of the modification parameter from an identity matrix, the precomputed SINR value, and twice an amplitude of the channel estimation error.

16. The apparatus of claim 15, wherein the precomputed SINR value is based on a multiplication of a conjugate of the estimated channel matrix, the inverse of the channel covariance matrix, and the estimated channel matrix.

17. The apparatus of claim 15, wherein the instructions, when executed by the processor, cause the apparatus to modify the channel capacity by, for each layer:
determining a difference between an identity matrix and a product of the modification parameter, the precomputed SINR value, and twice the amplitude of the channel estimation error;
determining a value corresponding to a logarithm of the difference; and
summing values of each layer.

18. The apparatus of claim 15, wherein the instructions, when executed by the processor, cause the apparatus to determine the channel estimation error by:
determining a scaling parameter based on an absolute value of a computed error, and
determining an angle parameter based on dividing the channel estimation error by the absolute value of the computed error.

19. The apparatus of claim 11, wherein outputting the channel state information comprises comparing a scaling parameter to a predefined threshold.

20. The apparatus of claim 19, wherein the instructions, when executed by the processor, further cause the apparatus to:
in response to the scaling parameter satisfying the predefined threshold, re-computing the channel state information with the modified SINR and the modified channel capacity; or
in response to the scaling parameter not satisfying the predefined threshold, not re-computing the channel state information.
